(19) United States
(12) Patent Application Publication
(10) Pub. No.: US 2010/0065667 A1
(43) Pub. Date: Mar. 18, 2010

(54) ARM OF SPRAYING DEVICE

(76) Inventors: Pavel Vacek-Vesely, Brno (CZ); Danes Grula, Brno (CZ)

Correspondence Address: OSTROLENK FABER GERB & SOFFEN, 1180 AVENUE OF THE AMERICAS, NEW YORK, NY, 100368403, US

(21) Appl. No.: 12/447,553

(22) PCT Filed: Aug. 17, 2007
(86) PCT No.: PCT/CZ07/00081

§ 371 Date: Apr. 28, 2009

(30) Foreign Application Priority Data
Oct. 31, 2006 (CZ) PUV 2006-18220

(51) Int. Cl. B05B 3/00

(52) U.S. Cl. 239/723

(57) ABSTRACT

The arm of spraying device including the first part, which on its one end is provided with means for adjustable mounting on a frame of the spraying device, and which is provided with distribution piping of the spray and system of spraying nozzles, whereas the first part is formed by a three-dimensional composite body.

### TECHNICAL FIELD

Invention relates to the arm of spraying device, which comprises the first part, which on its one end is provided with means for adjustable mounting on a frame of the spraying device, and which is provided with distribution piping of the spray and system of spraying nozzles.

### BACKGROUND ART

The spraying device serves in agriculture for application of the spray on plants. The spraying devices comprise the chassis, on which the tank for water is mounted. The tank is connected with the distribution piping of the spray, which delivers the spray into the spraying nozzles. The spraying nozzles are together with a part of distribution piping mounted on arms, which are, as a rule adjustable between the working and transportation position, mounted on a frame of the spraying device. Generally, the spraying device comprises a pair of arms always one on each lateral side of the device. The spraying device itself may be performed as self-propelled one, i.e. it is formed by an independent vehicle with an independent control and a drive or it may be performed as a connecting vehicle, which is hitched behind a towing vehicle, e.g. tractor, while it is connected to the drives of the towing vehicle, so that the aggregates of the spraying device may work, or the spraying device may be performed as a suspension one, i.e. that it is hinged on a suitable holder on tractor or other self-propelled means. The spraying device is further provided with position stabiliser of arms in a horizontal direction and possibly also with further auxiliary devices, like the air cushions for blowing of a pressurized air in the direction of spraying to support the spraying especially in a windy weather, etc.

Known are the arms of spraying device, which have a classic three-dimensional lattice work made of steel girders. The disadvantage of these embodiments is a substantial weight of the arms, which increases loading of the spraying device, increases the fuel consumption in operation and enables to use only a smaller tank for the spray.

Known is also a production of a three-dimensional lattice work of spraying arms of non-ferrous metals, like alloys of aluminium, etc., which nevertheless results in reduction of weight of spraying arms when compared with the steel arms, but this does not remedy further shortcomings of the steel arms and arms of non-ferrous metals, which are caused by a dynamic loading of arms during operation of the spraying device, i.e. during ride in a filed, when due to loading of arms there is a material fatigue, creep of material and occurrence of further material defects, so that after some time it is necessary to replace the known arms by another ones.

The goal of the invention is to remedy or at least to minimize the disadvantages of the present state of the art.

### THE PRINCIPLE OF INVENTION

The goal of the invention has been reached by an arm of the spraying device, comprising the first part, which is on one its end provided with means for adjustable mounting on a frame of the spraying device, and which is provided by a distribution piping of the spray and a line of spraying nozzles, while the principle of the solution lies in that the first part is formed by a three-dimensional composite body.

Advantageous embodiments of the invention are described in description of exemplary embodiments and in dependent claims for protection.

### DESCRIPTION OF THE DRAWING

Invention is schematically represented on the drawing where

FIG. 1 shows the arm of spraying device formed by one part only,

FIG. 1a the B-B section from the FIG. 1 in embodiment of the part without the stiffening partition,

FIG. 1b the B-B section from the FIG. 1 in embodiment of the part with the stiffening partition,

FIG. 2 shows the arm of spraying device formed by two parts,

FIG. 3 the arm of spraying device formed by three parts,

FIG. 4 the arm of spraying device formed by three parts and with the lightened third part,

FIG. 4a the A-A section with the lightened third part.

### EXAMPLES OF EMBODIMENT

The arm of the spraying device comprises at least the first part 1, which on its one end is provided with means 2, in the drawing are represented schematically only, for adjustable, respectively tiltable mounting of the arm 1 on the not represented frame of the spraying device.

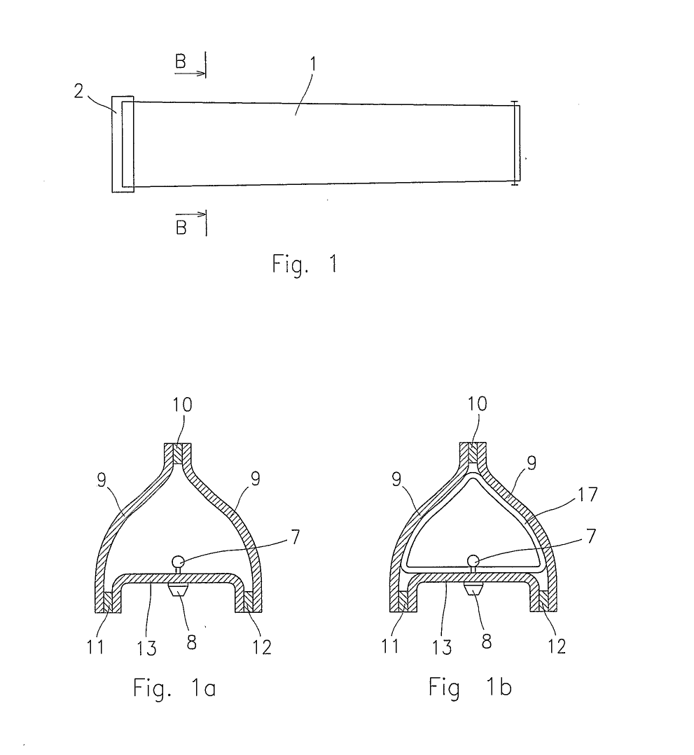

In an example of embodiment in the FIG. 1 the arm of the spraying device comprises the first part 1 only.

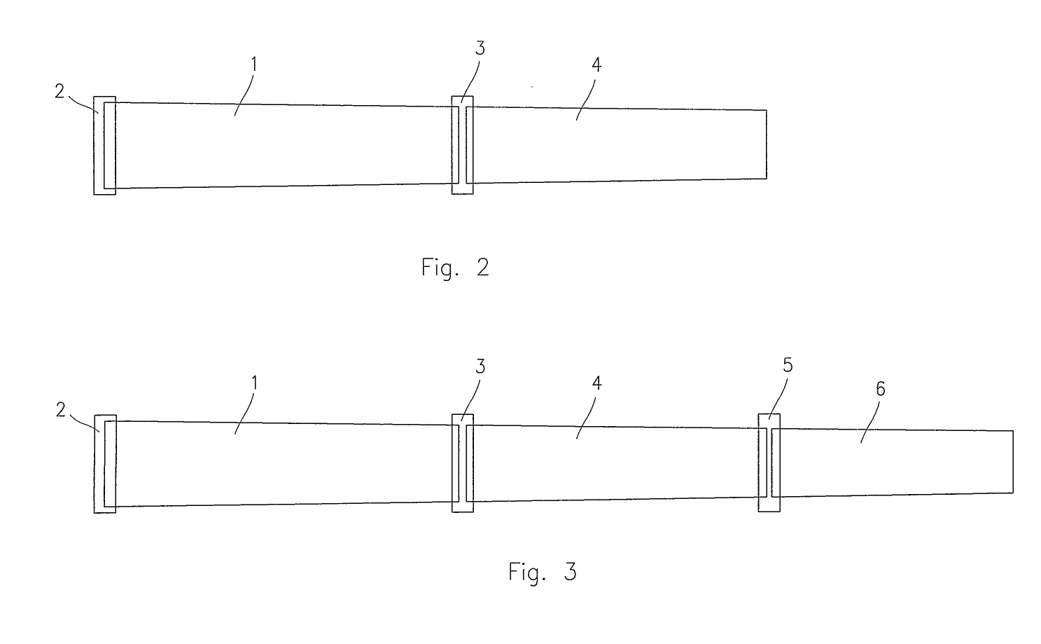

In an example of embodiment represented in the FIG. 2 the first part 1 on its second end is provided with means 3 for adjustable, respectively tiltable mounting of the second part 4 of the arm of spraying device.

In an example of embodiment represented in the FIG. 3 the second part 4 on its end is provided with means 5 for adjustable, respectively tiltable mounting of the third part 6 of the arm of spraying device.

Individual parts 1, 4, 6 of the arm of spraying device are provided with distribution piping 7 of the spray, which are connected to the spraying nozzles 8 positioned in a line one after another in the direction of an arm length on individual parts 1, 4, 6 of the arm of spraying device.

In examples of embodiment represented in the FIGS. 1 to 4 the individual parts 1, 4, 6 of the arm of spraying device are formed of a three-dimensional composite body.

In an example of embodiment represented in the FIG. 1a the three-dimensional composite body is formed by a pair of composite slab side plates 9, which on the upper end of the body are attached to the upper auxiliary beam 10, which is also made of composite. On the lower end of the body one of the side plates 9 is attached on the composite first lower auxiliary beam 11, while the second side plate 9 is attached on the composite second lower auxiliary beam 12. On a lower end of the body between the both lower auxiliary beams 11, 12 there is attached the composite slab bottom 13, which closes the body. On the bottom 13 there are performed the attachment means for mounting of the distribution piping 7 of the spray and for mounting of the spraying nozzles S. In the represented example of embodiment the distribution piping 7 is positioned in an inner area of the three-dimensional composite body. In the not represented example of embodiment the distribution piping 7 is positioned on an outer side of the three-dimensional composite body.

In an example of embodiment represented in the FIG. 1b in a cavity of the parts 1, 4, 6 of the arm of spraying device there is mounted at least one reinforced rib 17. In an example of embodiment represented in the FIG. 1a the individual parts 1, 4, 6 of the arm of spraying device are performed without reinforced ribs 17 in cavity of the parts 1, 4, 6 of the arm of spraying device.

In the not represented example of embodiment the side plates 9 mutually and each of the side plates 9 with one end of the bottom 13 are connected directly, i.e. without auxiliary beams 10, 11, 12. In another not represented example of embodiment the auxiliary beams 10, 11, 12 are applied only in the end areas of each of the parts 1, 4, 6 of the arm of spraying device, this especially with the aim to increase stiffness and endurance for connection of the means 2, 3, 5 for adjustable, respectively tiltable mounting of the arm on a frame of the spraying device or mutual mounting of individual parts 1, 4, 6 of the arm of spraying device. In another not represented example of embodiment the auxiliary beams 10, 11, 12 are an integral part of the side plates 9 and/or of the bottom 13, which is enabled by the production technology of composite parts, and the side plate 9 and the bottom 13 are connected directly.

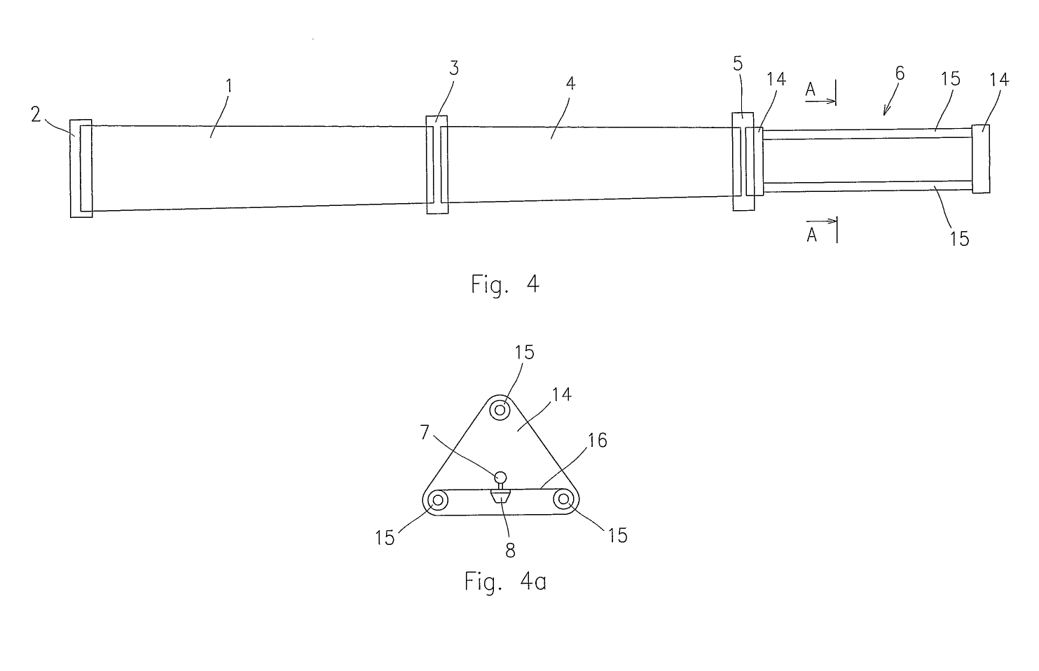

In an example of embodiment represented in the FIG. 4b the third part 6 of the arm of spraying device is performed as an lightened one, while it comprises a pair of composite end pieces 14, which are interconnected by means of three composite tubes and/or rods 15, which are with advantage arranged into a triangle, while the lower pair of composite tubes and/or rods 15 carries, e.g. by means of connecting strips 16, the distribution piping 7 of the spray and spraying nozzles 8. In the not represented example of embodiment in which the arm of spraying device contains only the first part 1 and the second part 4, the first part 1 is performed in the same way as in the example of embodiment in the FIG. 1 and the second part 4 is performed as lightened one, e.g. as an embodiment of the third part 6 in the FIG. 4.

The means 2, 3, 5 for adjustable, respectively tiltable mounting are formed by a suitable mechanical system, e.g. system of tilting suspensions, etc. The means 2, 3, 5 for adjustable, respectively tiltable mounting are performed either from metal or they are made of composite or they are combined, etc.

In the not represented example of embodiment on the three-dimensional composite body there is mounted at least one air cushion equipped with air outlets to support transfer of the spray from the nozzles 8 to the plants. In another not represented example of embodiment the air cushion is mounted in the inner area of the three-dimensional composite bodies. In another not represented example of embodiment the air for support the transfer of the spray from the nozzles 8 is positioned directly in a suitable cavity in the three-dimensional composite bodies, which are provided by a suitable outlets of this air. Collectively, this embodiment creates the means to support transfer of the spray from nozzles 8 to the plants.

In another not represented example of embodiment the arm is at least on one its part provided with at least one lightening and/or installation and/or servicing opening, which is or is not covered.

Individual composite parts of the arm of spraying device are made of a suitable composite, e.g. are made of fibrous composite, which exemplary has a polymer matrix. The composite has a suitable structure in that respect that the fibres or individual fibrous layers are laid as it is known from the technology for production of composite parts. With advantage, the fibres are made of carbon, glass or polymer or some other material.

According to the not represented example of embodiment at least one part of the arm of spraying device is formed by a three-dimensional composite body, which has an enclosed continuous cross-section and it is made through technology of composite production by means of winding the fibres, e.g. it is performed by a technology of axial laying of fibres with small or zero angle (zero degree axial fibre laying process). The section of the arm of spraying device, performed in this manner, has a suitable shape of its cross-section, which according to one example of embodiment is constant along a whole length of the section of the arm of spraying device, or according to another advantageous embodiment is variable in the direction of the length of the section of the arm of spraying device. According to one advantageous example of embodiment the section of the arm of spraying device, performed in this manner, has a constant thickness of the wall. According to another advantageous example of embodiment the section of the arm of spraying device, performed in this manner, has a variable thickness of the wall, which may be variable in the direction of a length of the arm section and/or circumference of the arm section. To improve the properties of end areas of the arm section of spraying device the end areas are reinforced. On a lower side of the body, performed in this manner, there is attached a row of nozzles 8 for the spray. The nozzles 8 are connected to a suitable reservoir for the spray. In a not represented embodiment the spray distribution piping to individual nozzles is created by an independent distribution system positioned either in a cavity of the three-dimensional composite body or on an outer side of the three-dimensional composite body. In another not represented example of embodiment in the inner area of the three-dimensional composite body there is arranged at least one hollow longitudinal stiffener, whose cavity serves for distribution of the spray to nozzles 8, which are connected to the cavity of the longitudinal stiffener.

The inner area of the three-dimensional composite body made through technology of composite production by means of winding the fibres may be also relatively simply sealed and used as an reservoir of an air to support the transfer of the spray from nozzles 8 to the plants. For this purpose on a lower side of such performed section of the arm of spraying device there are performed openings for air outlet or for positioning of lockable nozzles for air outlet.

The invention is not limited only to here expressly mentioned or represented embodiments, because modification of basic ideas of this solution to another particular structural embodiment is within mere specialised skill.

### INDUSTRIAL APPLICABILITY

The invention is applicable in agriculture.

1. An arm of a spraying device comprising a first part, which has one end provided with means for adjustable mounting on a frame of the spraying device, and which has distribution piping of the spray and system of spraying nozzles, the first part is formed by a three-dimensional composite body, which has an enclosed continuous cross-section and is made through technology of composite production by means of winding the fibres with small or zero angle, and the three-dimensional composite body comprises a hollow inner area for an air reservoir to support transfer of the spray from nozzles to plants.

2. The arm according to the claim 1, wherein the first part has a second end provided with means for adjustable mounting of a second part of the arm of spraying device, and the second part is formed by a three-dimensional composite body.

3. The arm according to the claim 2, wherein the second part on its second end is provided with means for adjustable mounting of a third part of the arm of spraying device, and the third part is formed by a three-dimensional composite body.

4. (canceled)

5. (canceled)

6. (canceled)

7. (canceled)

8. (canceled)

9. (canceled)

10. (canceled)

11. (canceled)

12. (canceled)

13. The arm according to claim 1, wherein a cross-section of section of the arm is variable in a direction of a length of the arm section.

14. The arm according to claim 1, wherein a cross-section of section of the arm is constant in a direction of a length of the arm section.

15. The arm according to claim 1, wherein the three-dimensional composite body has a variable thickness of a wall in the direction of its circumference and/or its length.

16. The arm according to claim 1, wherein the three-dimensional composite body has a constant thickness of a wall in the direction of its circumference and/or its length.

17. The arm according to claim 1, wherein the three-dimensional composite body is reinforced on its end areas.

18. (canceled)

19. (canceled)

20. (canceled)

21. The arm according to claim 1, wherein the three-dimensional composite body is provided with at least one hollow longitudinal stiffener.

22. The arm according claim 1, wherein the three-dimensional composite body on its lower side is provided with openings for air outlet and/or for positioning of lockable nozzles for air outlet.
